(19) United States
(12) Patent Application Publication
(10) Pub. No.: US 2015/0083070 A1
(43) Pub. Date: Mar. 26, 2015

(54) ARRANGEMENT COMPRISING A CYLINDER HEAD AND A PRECHAMBER SYSTEM

(71) Applicant: GE Jenbacher GmbH & Co OG, Jenbach (AT)

(72) Inventor: Florian BECKER, Maurach a.A. (AT)

(21) Appl. No.: 14/487,363

(22) Filed: Sep. 16, 2014

(30) Foreign Application Priority Data
Sep. 25, 2013 (AT) 737/2013

(51) Int. Cl. F02B 19/16; F02F 1/26

(52) U.S. Cl. CPC F02B 19/16; F02F 1/26; F02F 2001/249
USPC 123/254

(57) ABSTRACT

An arrangement comprising a cylinder head and a prechamber system for an internal combustion engine, wherein the cylinder head has a flame plate for delimiting a main combustion chamber and the prechamber system is at least partially arranged in an opening in the flame plate, wherein there is provided a cooling cavity substantially surrounding the prechamber system and arranged in the flame plate and/or in that region of the prechamber system that is in the opening.

The present invention concerns an arrangement comprising a cylinder head and a prechamber system for an internal combustion engine having the features of claim 1.

Particularly in the case of gas engines but also in the case of internal combustion engines in general prechamber systems can be used for ignition of a combustion mixture in a main combustion chamber. Those prechamber systems generally have a precombustion chamber in which a relatively easily ignitable combustion mixture can be ignited. An ignition flare is produced, which is fed to the main combustion chamber by way of a riser passage and bores.

That described prechamber system is generally arranged in a one-piece component which is then mounted in an opening in the flame plate. The term flame plate is used to denote that part of the cylinder head, that defines the main combustion chamber in the region of the ignition device—in this case therefore the prechamber system.

In most cases the prechamber component and the flame plate are those components of the internal combustion engine, that are exposed to the highest loadings. In particular some of the highest temperatures occur here during operation of the internal combustion engine. Consequently the service lives of the prechamber system and the flame plate are crucial factors for the longevity of internal combustion engines of the general kind set forth.

The object of the invention is to provide an arrangement comprising a cylinder head and a prechamber system, which allows increased service lives in comparison with the state of the art.

That object is attained by an arrangement having the features of claim 1.

That is achieved in that there is provided a cooling cavity substantially surrounding the prechamber system and arranged in the flame plate and/or in that region of the prechamber system that is in the opening. The invention is based on the surprising realization that, in regard to service life, the thermal loading reduced by the cooling action offsets the mechanical weakening of the components involved. Those components, the flame plate and generally a prechamber component and seals if provided, therefore withstand the mechanical stresses occurring, in spite of the presence of the cooling cavity, and are capable of increased service lives by virtue of the reduced temperature.

Further advantageous embodiments of the invention are defined in the appendant claims.

The cooling cavity according to the invention can be implemented in a particularly simple fashion if the at least one prechamber component has a surrounding groove which together with an inside wall of the opening in the flame plate forms the cooling cavity, wherein the inside wall of the opening is arranged preferably substantially radially with respect to a longitudinal axis of the prechamber system.

A particularly preferred embodiment is one with passages for feeding and discharging a cooling medium, that are connected to the cooling cavity. The dissipation of heat can be improved by the continuous exchange of the cooling medium in the cooling cavity.

In order to avoid cooling medium issuing from the cooling cavity there are preferably provided two—preferably annular—seals for sealing off the cooling cavity.

A particularly simple structure for the passages can be achieved if the passages are—preferably completely—arranged in the flame plate.

In addition a particularly preferred embodiment is one in which the cooling cavity has an inlet opening and an outlet opening spaced from the inlet opening for temperature control medium, wherein the inlet opening and the outlet opening are respectively connected to passages. By virtue of the cooling medium which continuously flows past in operation the dissipation of heat which is made possible by the cooling cavity can be further improved and optimized.

Liquids can be used as the cooling medium. By virtue of their thermal capacity and their heat conduction properties water, aqueous mixtures or oil are particularly preferred in that respect.

It is however also possible to use gases, in particular compressed air, as the cooling medium. That has the advantage over liquids as the cooling medium that small leakage levels can be tolerated and therefore less complication and expenditure has to be involved for sealing off the cooling cavity and possibly the passages.

A further preferred embodiment is one in which the cooling cavity is substantially annular. That permits a uniform discharge of heat in all directions.

The cooling cavity can be adapted to the shape of the prechamber system by the cooling cavity being of a substantially polygonal cross-section with respect to a longitudinal axis of the prechamber system. The result is a further improvement in the dissipation of heat.

That applies in particular when the prechamber system includes a riser passage and bores for guiding an ignition flare to the main combustion chamber, the cooling cavity substantially surrounding the riser passage.

In addition protection is claimed for an internal combustion engine having a cylinder head according to the invention.

Further details and advantages of the invention will be apparent from the Figures and the related specific description. In the Figures:

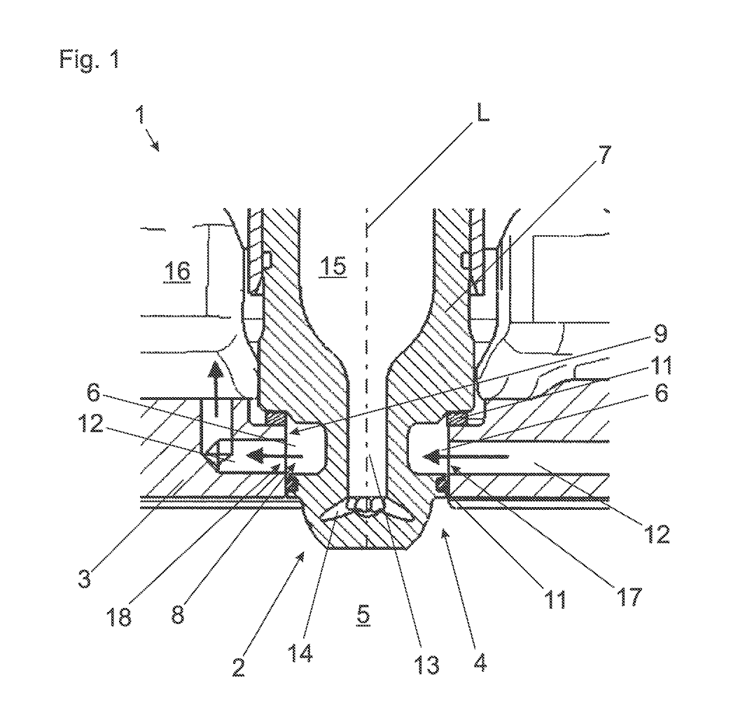

FIG. 1 shows an arrangement according to the invention comprising a cylinder head and a prechamber system, and

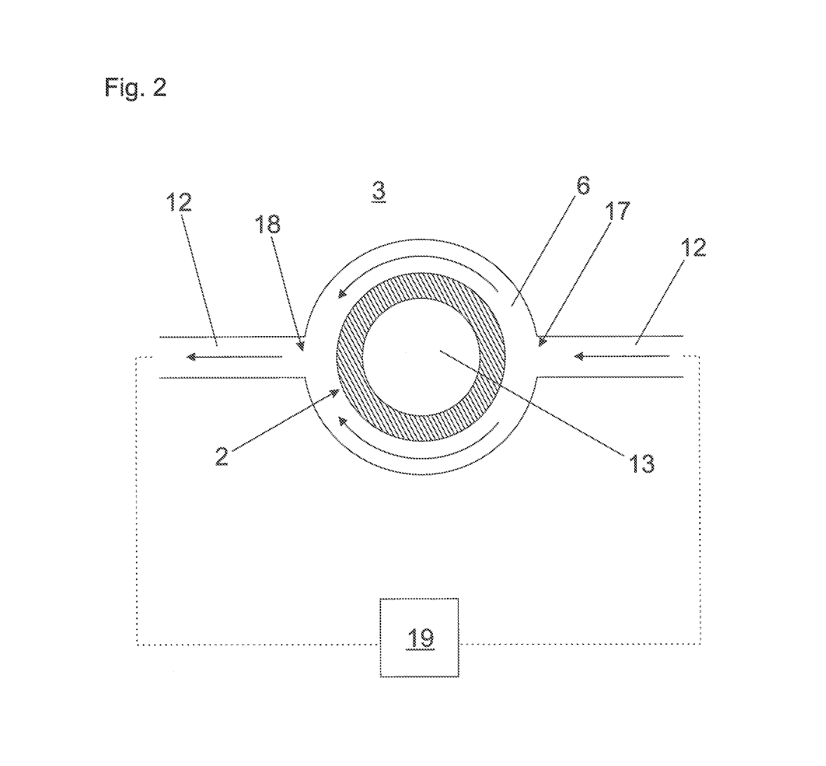

FIG. 2 shows a diagrammatic sectional view through the arrangement according to the invention in the plane of the cooling cavity.

FIG. 1 shows a cylinder head 1 according to the invention with prechamber system 2 as a sectional view. In this embodiment the prechamber system 2 includes a precombustion chamber 15, a riser passage 13 and a plurality of bores 14. the prechamber system 2 is arranged in an opening 4 in the flame plate 3. For the sake of simplicity of manufacture those parts of the prechamber system 2 are arranged in a single prechamber component 7. The cooling cavity 6 surrounds the riser passage 13 in an annular configuration.

The cooling cavity 6 is formed substantially by a groove 8 in the prechamber component 7 together with an inside wall 9 of the opening 4, in which the prechamber component 7 is arranged. Two seals 11 in the form of sealing rings are provided to seal off the cooling cavity 6.

The shape of the cooling cavity 6 is matched to the tubular shape of the riser passage 13 insofar as a surface delimiting the cooling cavity 6, facing towards the riser passage 13, is in the shape of a cylindrical peripheral surface. Together with surfaces which serve to fix the seals 11 the arrangement involves a polygonal cross-section for the cooling cavity 6 radially with respect to a longitudinal axis L.

In this embodiment the prechamber system is substantially symmetrical with respect to the longitudinal axis L. That however is not essential for the invention.

The inside wall 9 of the opening 4 in the flame plate 3 has an inlet opening 17 and an outlet opening 18. The cooling cavity 6 is connected to two passages 12 through those openings. Those passages 12 permit the feed and discharge of cooling medium to and from the cooling cavity 6. In that respect the flow direction is indicated by arrows.

Simple manufacture of the passages is achieved by producing two bores which are at a right angle to each other, in the absence of the prechamber component 7, wherein the one bore extends in the plane of the flame plate and the other perpendicularly thereto. That perpendicular bore makes it possible for cooling medium to be easily conveyed into the cooling jacket 16 of the cylinder head 1.

FIG. 2 shows a diagrammatic section through the flame plate 3 and the prechamber system 2 in the plane of the cooling cavity 6. The cooling cavity 6 surrounds the prechamber system 2 in the region of the riser passage 13. Cooling medium is conveyed into the cooling cavity 6 through the inlet opening 17 by way of a passage 12 by a diagrammatically illustrated pump 19. The flow indicated by arrows leaves the cooling cavity 6 through the outlet opening 18. The cooling medium passes to the pump 19 again by way of the passage 12.

Typically the pump 19 is so designed that flow speeds of between 0.5 m/s and 10 m/s are achieved in the cooling cavity 6.

The present invention is not limited to the embodiment illustrated here. For example, instead of the groove 8 in the prechamber component 7 it is possible to provide a respective step in the prechamber component 7 and in the flame plate 3, the steps cooperating to form the cooling cavity 6. It is however also readily possible for the cooling cavity to be integrated into the prechamber component. A cooling cavity which is arranged in an annular configuration around the opening and which is spaced from the prechamber component 6 is however also conceivable.

1. An arrangement comprising a cylinder head and a prechamber system for an internal combustion engine, wherein the cylinder head has a flame plate for delimiting a main combustion chamber and the prechamber system is at least partially arranged in an opening in the flame plate, wherein there is provided a cooling cavity substantially surrounding the prechamber system and arranged in the flame plate and/or in that region of the prechamber system that is in the opening.

2. An arrangement as set forth in claim 1, wherein the prechamber system is arranged in at least one prechamber component.

3. An arrangement as set forth in claim 2, wherein the at least one prechamber component has a surrounding groove which together with an inside wall of the opening in the flame plate forms the cooling cavity, wherein the inside wall of the opening is arranged preferably substantially radially with respect to a longitudinal axis of the prechamber system.

4. An arrangement as set forth in claim 1, wherein there are provided two—preferably annular—seals for sealing off the cooling cavity.

5. An arrangement as set forth in claim 1, wherein there are provided passages connected to the cooling cavity for feeding and discharging a cooling medium.

6. An arrangement as set forth in claim 5, wherein the passages are arranged—preferably completely—in the flame plate.

7. An arrangement as set forth in claim 5, wherein the cooling cavity has an inlet opening and an outlet opening spaced from the inlet opening for temperature control medium, wherein the inlet opening and the outlet opening are respectively connected to passages.

8. An arrangement as set forth in claim 1, wherein liquids, in particular water, aqueous mixtures or oil, can be used as the cooling medium.

9. An arrangement as set forth in claim 1, wherein gases, in particular compressed air, can be used as the cooling medium.

10. An arrangement as set forth in claim 1, wherein the cooling cavity is substantially annular.

11. An arrangement as set forth in claim 1, wherein the cooling cavity is of a substantially polygonal cross-section with respect to a longitudinal axis of the prechamber system.

12. An arrangement as set forth in claim 1, wherein the prechamber system has a riser passage and bores for guiding an ignition flare to the main combustion chamber, wherein the cooling cavity substantially surrounds the riser passage.

13. An internal combustion engine having an arrangement as set forth in claim 1.
